(19) United States
(12) Patent Application Publication
(10) Pub. No.: US 2011/0089656 A1
(43) Pub. Date: Apr. 21, 2011

(54) MANUAL-SWINGING SCOOTER

(76) Inventors: Po-Lin Chiu, Kaohsiung City (TW); Sherng-Ji Tsay, Kaohsiung City (TW); Ching-Piao Chang, Fong Shan City (TW)

(21) Appl. No.: 12/683,366

(22) Filed: Jan. 6, 2010

(30) Foreign Application Priority Data
Oct. 15, 2009 (TW) 098219000

(51) Int. Cl. B62M 1/00

(52) U.S. Cl. 280/87.041

(57) ABSTRACT

A manual-swinging scooter includes a steering stem with a handle, a fixture extending therefrom, two main frames with treadles outwardly extending from the fixture, and a wheel assembly connected to the fixture and the main frames, respectively. A swingable assembly pivotally disposed between each main frame and frame wheel has a support seat vertically coupled to the main frame, a base with a bevel surface inclinably disposed on the support seat, a rotary shaft pivoting to the support seat, a connecting shaft respectively engaged with the rotary shaft and the frame wheel, and a brace disposed on the connecting shaft for slidably propping against the bevel surface and for the connecting shaft to swing relative to the bevel surface.

### BACKGROUND OF THE INVENTION

1. Field of the Invention

The present invention relates to a scooter design, particularly to a manual-swinging scooter.

2. Description of the Related Art

Generally, a typical scooter needs an incessant foot-propelling to maintain the sliding, which not only results in the tiredness of feet but decreases the user's pleasure and interest in riding the conventional scooters. Hence, another improved scooter is constructed to allow putting feet on the treadles and performing a s-track forwarding by waggling one's waist and buttocks. An example of U.S. Pat. No. 6,485,039 issues two pedal rods pivotally disposed on a handle supporting stem and two rear wheels outwardly engaged to rear ends of the plates. Each rear wheel is rotatably coupled to a swingable fork member that is connected to a C-shape hook. Another example of U.S. Pat. No. 7,549,655 as shown in FIG. 1, it briefly issues a stand rod 10 with handlebars, a frame 11 extended from the stand rod 10, two pedal rods 12 connected to the stem 11, two treadles 121 disposed on the pedal rods 12, and a front and two rear wheels 13,14 rotatably coupled to the stem 11 and the rods 12, respectively; wherein, two fork members 122 are extensibly and respectively coupled to the rear wheels 14 toward a direction away from the stem 11, and each of which provides a pivot member 123 slantingly and pivotally fitted on the pedal rod 12 for permitting a free sway.

However, similar problems and difficulties may encounter with the above conventional structures as follows:
1. In view of the pivot member 123 extending outward from the pedal rod 12 and communicating with the outside to pivotally engage to the fork member 122, the pivot member 123 and the fork member 122 would define a space at their engagement. In case of some barriers such as broken rocks, sands, mud, etc. are leaped while riding, they may jump up and adhesively accumulate within the space with ease to limit the sway of the pivot member 123, the fork member 122 and thence the rear wheel 14, which thus incurs a problem of interference during the swinging and even hurts the user.
2. From the above, the direct connection of the fork member 122 with the pivot member 123 for promoting a direct sway may result in clamping user's hand if he or she puts their hands into the space for removing those barriers but at the same time carelessly triggers a sway of the fork member 122.
3. The rear wheels 14 of the conventional scooters are merely restricted to perform a left-right sway due to the engagement of the fork member 122 and the pivot member 123, which is however ineffective for riding on a detective road. When one rear wheel 14 drops into a hole in the ground, the scooter 1 would lose balance at its two sides and fail to keep forwarding. Such dropping would inevitably result in overturning the scooter 1 as well and would nevertheless harm the user.
4. In regard to U.S. Pat. No. 7,549,655 having the pivot member 123 slantingly fitted on the pedal rod 12 in FIG. 1, it leads the fork member 122 to downwardly and slantingly extending to connect with the rear wheel 14 and dispose the rear wheel 14 toward an inward inclination as shown in FIG. 2. Such arrangement may render the user unable to steadily and firmly tread on the treadles 121. Further, if the scooter is driven inclinedly toward one side, the rear wheels 14 substantially fail to support the inclination of the scooter 1 and would gravitate to the inclined side, which brings the user an unstable barycenter and hardily keeps his balance while riding.
5. When the scooter 1 is collapsed, the inward inclination of the rear wheels 14 would contradict with each other and restrict the rotation of the rear wheels, which leads users to incapably pulling or dragging the scooter, thus requiring improvements.

### SUMMARY OF THE INVENTION

The object of the present invention is to provide a manual-swinging scooter, which preferably prevents problems of getting an unsteady barycenter during the riding as well as harming users due to unexpected rushing of barriers into components and preferably promotes a buffer while riding on a defected ground, hence increasing operating safety and convenience.

The manual-swinging scooter in accordance with the present invention a steering stem for controlling directions, a fixture extending downwardly from the steering stem, two main frames outwardly extending from the fixture provided with two treadles disposed thereon, and a wheel assembly including a steering wheel and at least two frame wheels pivoted to the fixture and the main frames, respectively. Between each main frame and the frame wheel, a swingable assembly is pivotally disposed and includes a support seat vertically coupled to the main frame, a base fixed on the support seat, a rotary shaft pivoting to the support seat, a connecting shaft provided pivotally and respectively engaged with the rotary shaft and the frame wheel, and a brace disposed on the connecting shaft. Wherein, the base defines a bevel surface inclined with respect to the support seat, so that the brace props against the bevel surface and slides thereon for allowably swinging the connecting shaft relative to the bevel surface. Accordingly, the engagement of the brace with the bevel surface aids in effectively blocking the entry of barriers for keeping a smooth sway of the connecting shaft and decreasing the occurrence of harming users' hands for the purpose of obviating the barriers. Additionally, the swingable assembly not only conduces to a stable treading on the treadles and a smooth forwarding via a manually wriggling method. Such concatenation of interrelated elements helps the connecting shaft and the frame wheels adjust their swinging orientations to meet the scooter's status to prevent them from over inclining toward one side when the scooter is subjected to a slanting force. The disposition of the connecting shaft relative to the bevel surface preferably promotes a buffer while riding on a defected ground, thus preferably increases operating safety and convenience.

An object of the invention is to provide a manual-swinging scooter which comprises a steering stem having a handle disposed on a top end thereof; a fixture extending downwardly from the steering stem, opposite to the handle; a pair of main frames extending outwardly from the fixture with two treadles separately disposed on the main frames; and a wheel assembly including a steering wheel pivotally connected to a distal end of the fixture and at least two frame wheels pivotally engaged to the main frames, respectively. Characterized in that a swingable assembly is pivotally disposed between each of the main frames and each of the frame wheels; the swingable assembly further includes a support seat vertically coupled to the main frame, a base fixed on the support seat, a rotary shaft pivoting to the support seat, a connecting shaft provided with two ends thereof pivotally and respectively engaged with the rotary shaft and the frame wheel, as well as a brace disposed on the connecting shaft. Wherein, the base has a bevel surface inclined with respect to the support seat, and the brace propping against the bevel surface and equipping to slide thereon for allowably swinging the connecting shaft relative to the bevel surface.

Preferably, the bevel surface is inclined with respect to the support seat by an angle range of 40-80 degrees.

Preferably, the swingable assembly is surrounded by a sheath member for keeping the swingable assembly free of the entry of barriers.

Preferably, the bevel surface provides two opposite projecting portions disposed thereon to limit a swinging angle of the connecting shaft range of 100-140 degrees.

Preferably, a supporting frame has one end thereof connected to the fixture and thence with the other end thereof pivotally engaged with the main frames; the supporting frame further has a footboard disposed thereon.

Preferably, an adjustable device is disposed at a connection of the supporting frame and each of the main frames and includes two pivoted units respectively disposed on the supporting seat and the main frame and two fastening units securely disposed on the pivoted units.

Preferably, a skate assembly is pivotally disposed instead of the wheel assembly.

Preferably, a brake device is operatively secured to the handle, which includes at least one brake lever fastened to the handle, a brake pad mounted on the wheel assembly, and a brake cable connecting the brake lever with the brake pad.

The advantages of the present invention over the known prior arts will become more apparent to those of ordinary skilled in the art upon reading the following descriptions in junction with the accompanying drawings.

### BRIEF DESCRIPTION OF THE DRAWINGS

FIG. 1 is a side view showing a conventional scooter issued by U.S. Pat. No. 7,549,655;

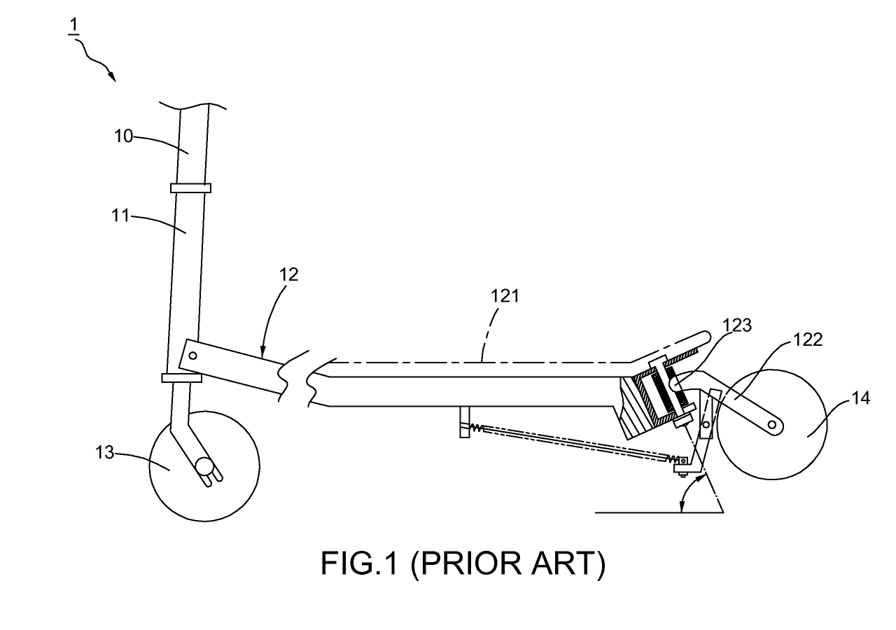

FIG. 2 is a schematic view showing the riding of FIG. 1;

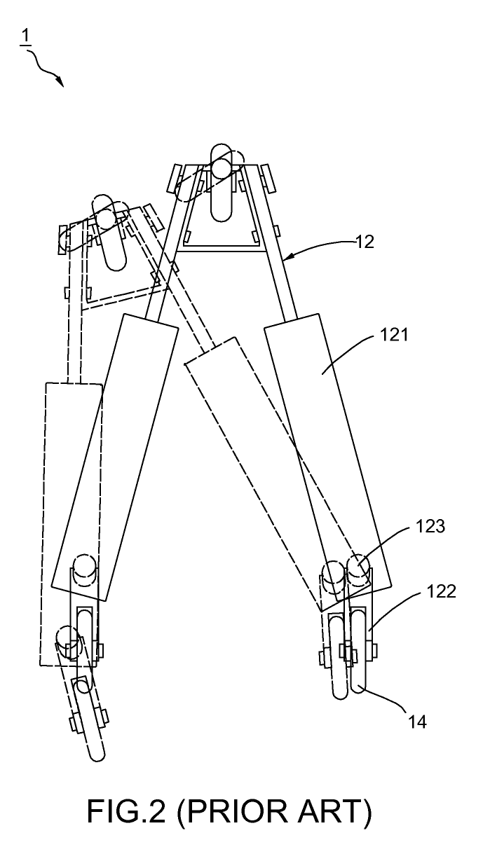

FIG. 3 is a perspective view showing a first preferred embodiment of the present invention;

FIG. 4 is an enlarged view of elements in the first embodiment;

FIG. 5 is a plan view showing of FIG. 4;

FIG. 6 is an end elevational view showing the first embodiment;

FIG. 7 is a schematic view showing the first embodiment of the scooter in a riding state;

FIG. 8 is a perspective view showing a top view of a second preferred embodiment of the present invention;

FIG. 9 is a perspective view showing a bottom side of the second preferred embodiment of the present invention;

FIG. 10 is a perspective view showing the second embodiment in a collapsible state; and

FIG. 11 is a perspective view showing a third embodiment of the present invention.

### DETAILED DESCRIPTION OF THE PREFERRED EMBODIMENTS

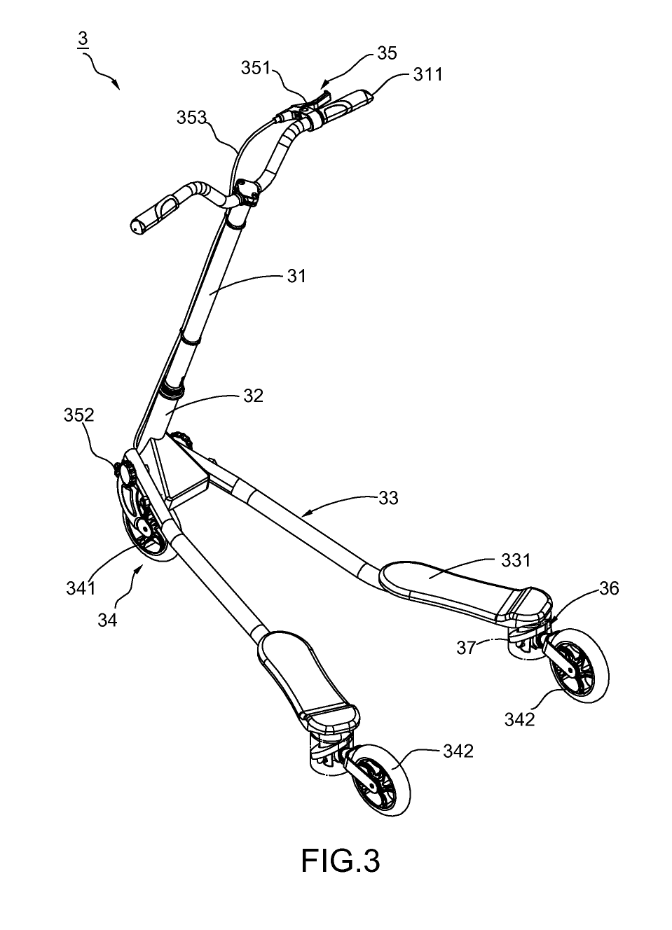

Referring to FIG. 3, a manual-swinging scooter 3 of a first preferred embodiment comprises a steering stem 31, a fixture 32 extending downwardly from the steering stem 31, a pair of main frames 33 directly extending outward from the fixture 32, and a wheel assembly 34 respectively connected to the fixture 32 and the main frames 33; wherein, the steering stem 31 has a handle 311 disposed on a top end thereof for controlling a forwarding direction, and the handle 311 preferably equips with a brake device 35 operatively secured thereto, which includes at least one brake lever 351 fastened to the handle 311, a brake pad 352 mounted on the wheel assembly 34, and a brake cable 353 connecting the brake lever 351 with the brake pad 352. Further, each of the main frames 33 has a treadle 331 disposed thereon; the wheel assembly 34 includes a steering wheel 341 rotatably connected to a distal end of the fixture 32 and at least two frame wheels 342 respectively engaged to the main frames 33 and located therebehind. Additionally, a swingable assembly 36 is pivotally disposed between each of the main frames 33 and each of the frame wheels 342.

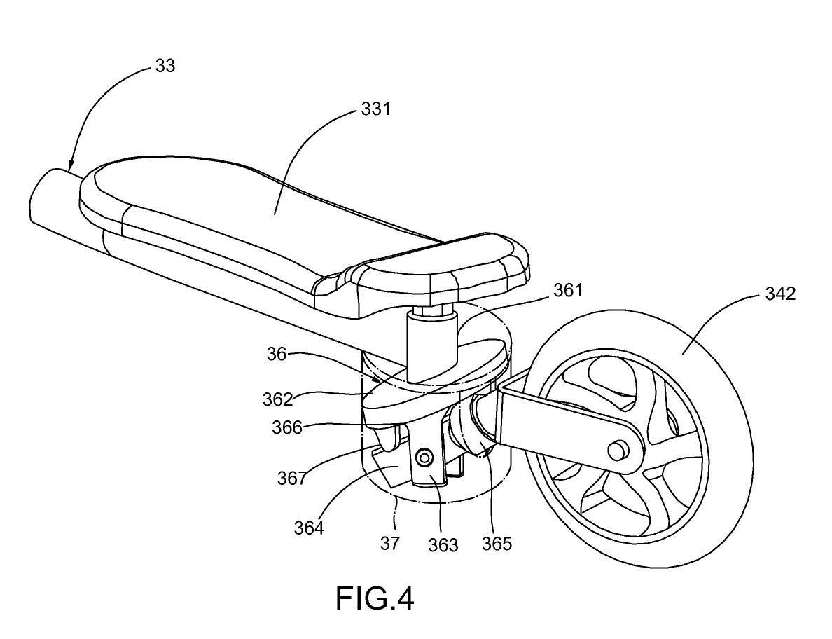

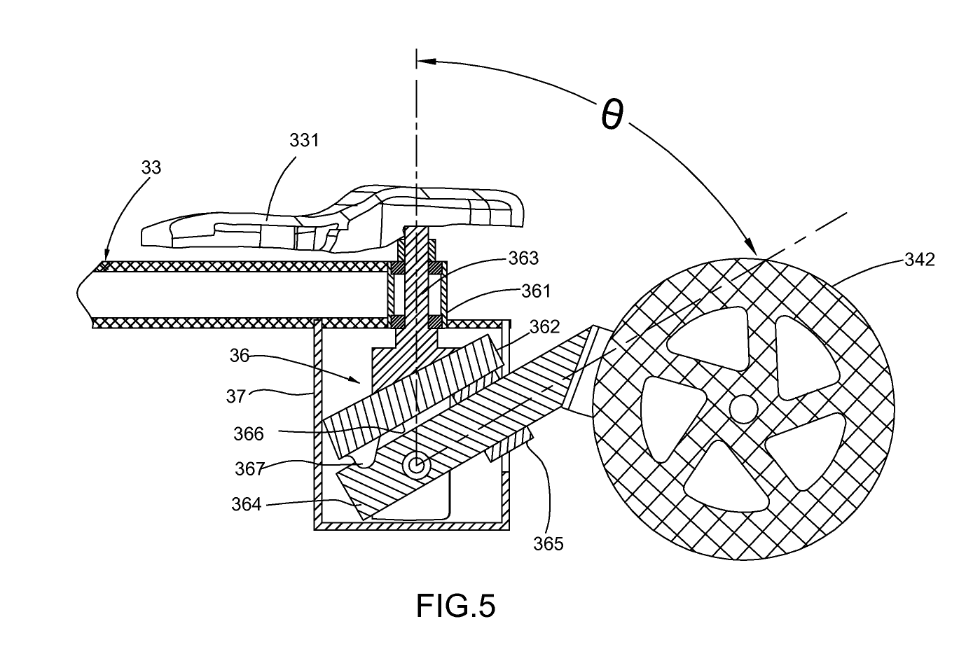

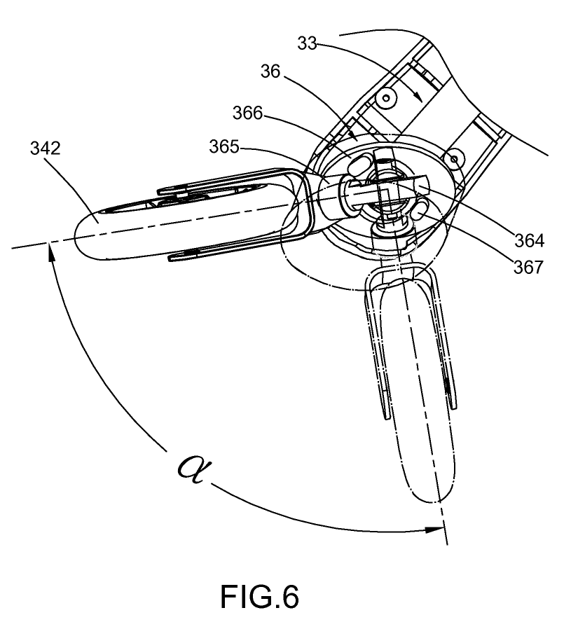

Accompanying with FIGS. 4 and 5, the swingable assembly 36 further has a support seat 361 coupled to the main frame 33 by a vertical orientation, a base 362 fixed on the support seat 361, a rotary shaft 363 pivoting to the support seat 361, a connecting shaft 364 provided with two ends thereof pivotally and respectively engaged with the rotary shaft 363 and the frame wheel 342, and a brace 365 disposed on the connecting shaft 364. Wherein, the base 362 forms a bevel surface 366 inclined with respect to the support seat 361 by an inclination angle θ range of 40 to 80 degrees, and herein the angle θ is preferably adopted by 60 degrees. The brace 365, serving as a bearing, a sleeve, or a rotary member, props against the bevel surface 366 and slide thereon for allowably swinging the connecting shaft 364 relative to the bevel surface 366. Herein, the brace 365 is adopted by a rotary sleeve design. Preferably, the bevel surface 366, as plainly shown in FIG. 6, also provides two opposite projecting portions 367 disposed thereon to limit a swinging angle a of the connecting shaft 364 range of 100 to 140 degrees, and herein a swinging angle a is adopted by 120 degrees. Still referring to FIG. 4, in terms of protecting the swingable assembly 36 from the attack of external factors for increasing the safety of utilization, the swingable assembly 36 herein is preferably surrounded by a sheath member 37, and the sheath member 37 could be penetrated by the connecting shaft 364 and be driven to rotate relative to the swinging of the connecting shaft 364. It should also note that the sheath member 37 is presented by dotted line in all of the embodiments for a clear showing of the components on the swingable assembly 36.

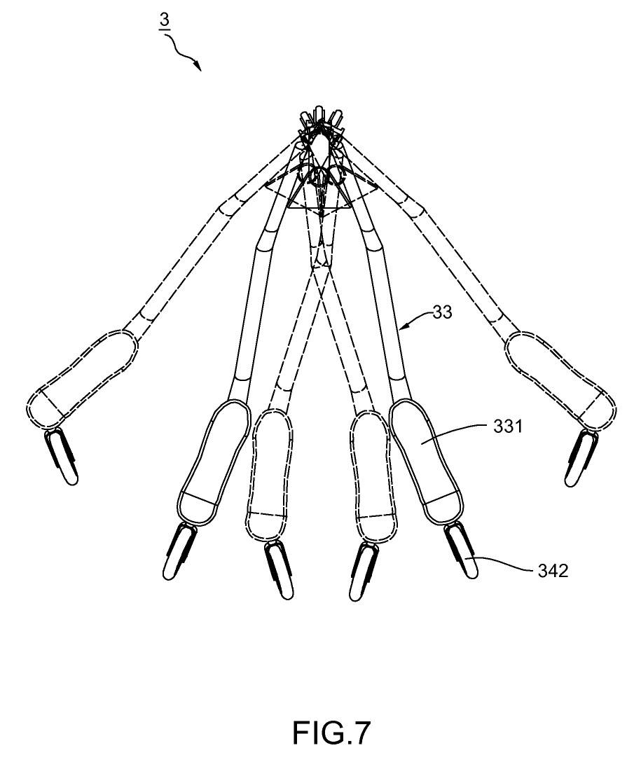

Referring to FIGS. 3 to 7, in use, when a user steps his feet on the two treadles 331, the configuration of the swingable assembly 36 with respect to the main frame 33 permits the respective alignment of the frame wheels 342 with the main frames 33, which facilitates to evenly distribute the user's weight and provide a supporting force, so that the present frame wheels 342, rather than the conventional rear wheels formed in an inward inclination, could allow the user to stably stand thereon and adequately exert strength on the treadles 331. Further the user grasps the handle 311 and manually wriggles his waist and buttocks to reciprocally propel a sway of the main frames 33 toward a leftward and a rightward motions and drive the revolution of the rotary shaft 363. The connecting shaft 364 would also perform in a left-right sway driven by the rotation of the rotary shaft 363. Hence, the frame wheels 342 would get a kinetic swinging motion to move the present scooter 3 forward along a free pathway. During the forwarding, by means of the brace 365 propping against the bevel surface 366 and accompanying with the block of the sheath member 37, barriers such as stones or sands, leaped up by reason of the passing of the frame wheels 342, would not facilely enter into or stick on the swingable assembly 36, so as to efficiently improve the problem of wasting time on removing the barriers and even incurring an unexpected wound in the user's hand.

Still further, if one of the frame wheels 342 get into a hole while forwarding or riding on a defected road, the inclination of the connecting shaft 364 with respect to the bevel surface 366, as a buffering mean, is substantially triggered to boost one end thereof up to contact the bevel surface 366, so as to confine the dropping of the wheel 342 into the hole and keep a smooth forwarding of the scooter 3. The entire scooter 3 may be inclinedly situated due to accelerating, turning, or other unexpected reasons. For meeting the inclination of the scooter 3 and the swingable displacement of the main frames 33, the connecting shafts 364 would adequately adjust their swing orientations and control the swinging of the frame wheels 342 under the restriction of the projecting portion 367, which assists the scooter 3 in counterbalancing the weight at two sides thereof, so as to avoid the frame wheels 34 to over gravitate to the inclined side of the scooter 3 and even to get tumbled down. In addition, under a high-speed riding, the user can alternatively grasp and squeeze the brake lever 351 for triggering the brake cable 353 to operate the brake pad 352, thereby slowing down the steering wheel 341 as well as frame wheels 342 or to stop them. Thus the present invention efficiently benefits of sustaining the user with a stable barycenter although the scooter 3 is subjected to an inclination and achieving purposes of increases operating safety and convenience.

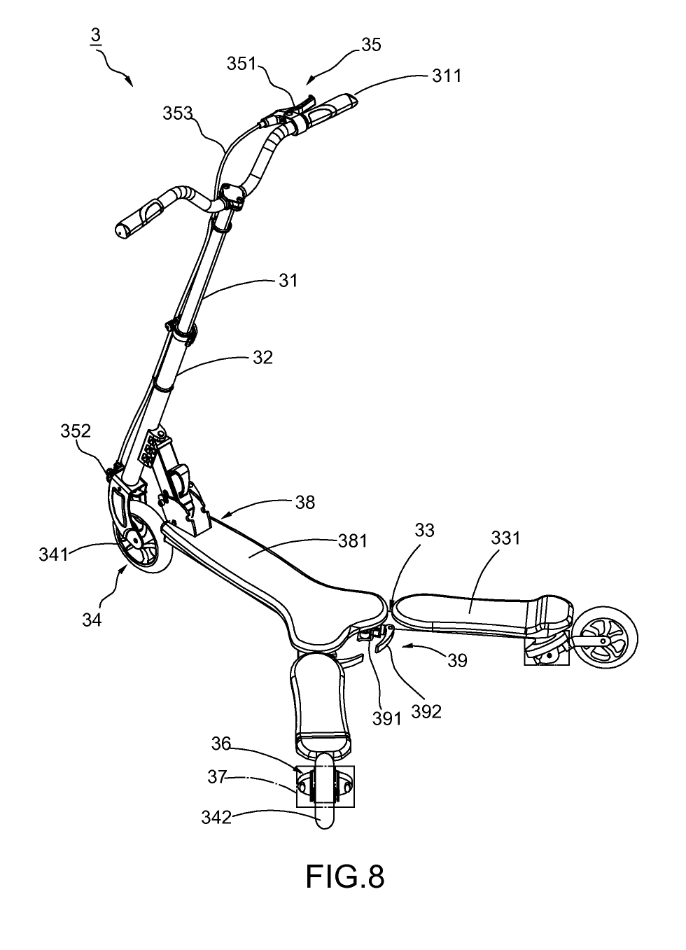

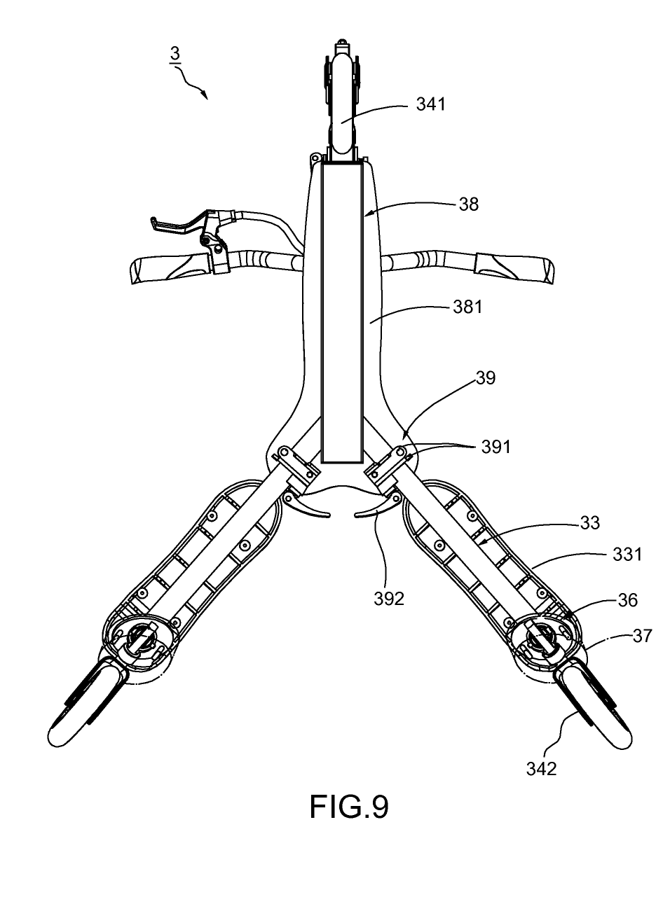

Referring to FIGS. 8 and 9, a manual-swinging scooter 3 of a second preferred embodiment is characterized in that a supporting frame 38 has one end thereof preferably connected to fixture 32 and with the other end thereof pivotally engaged with the main frames 33. Wherein, the supporting frame 38 has a footboard 381 disposed thereon for a user's treading. Further, an adjustable device 39 is disposed at a connection of the supporting frame 38 and each main frame 33. The adjustable device 39 further includes two pivoted units 391 respectively disposed on the supporting seat 38 and the main frame 33 and a fastening unit 392 securely disposed on the pivoted units 391, so as to permit a swingable displacement of the main frame 33 after releasing the fastening units 392.

In use, the user can have two manipulations to propel the scooter 3 going into a forward direction or into a free track. For example, tread both feet on treadles 331 of the main frames 33 and wriggle one's waist and buttocks to ride the scooter 3 forwards via a free sway pathway. Alternative, step one foot on the footboard 381, propel the scooter 3 into a forward direction by the other foot to push contacting with the ground, and further rest two feet thereon until a next continuous foot-propelling, thus promoting exercising and obtaining more pleasure.

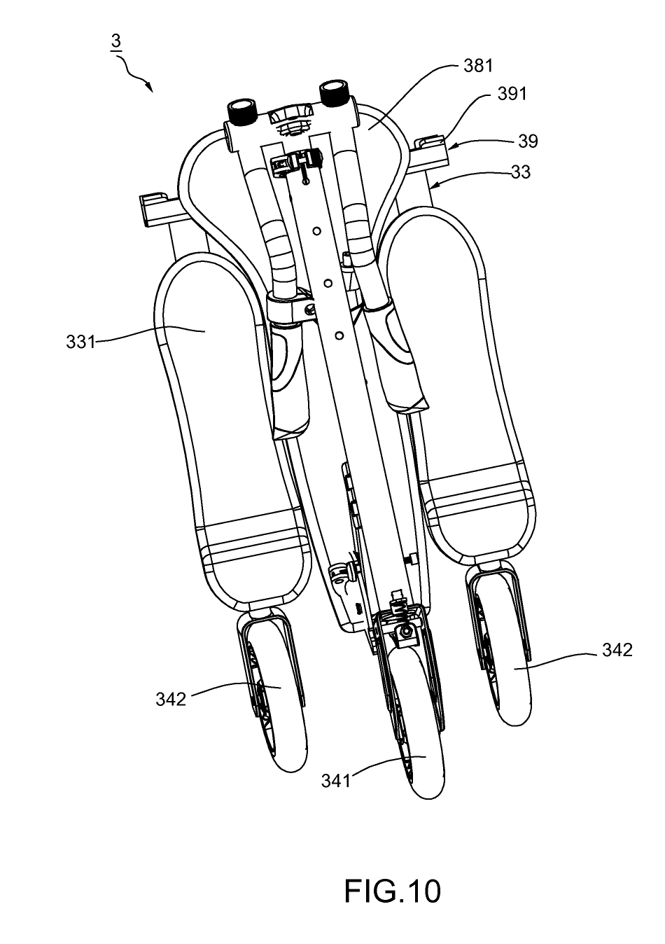

In non-using, the main frame 33 is foldably displaced toward the footboard 381 after liberating the pivoted units 33 from the control of fastening unit 392, thereby locating the treadles 331 at both sides of the footboard 381 for forming a collapsible state as plainly illustrated in FIG. 10, which would be easy storing. In this manner, since the frame wheels 342 are capable to be straight aligned with respect to their respective main frames 33, the user can directly pull and drag the frame wheels 342 and the steering wheel 341 to move the folded scooter 3 without any contradictory force, which is convenient for carrying and beneficial to convenience of utilization.

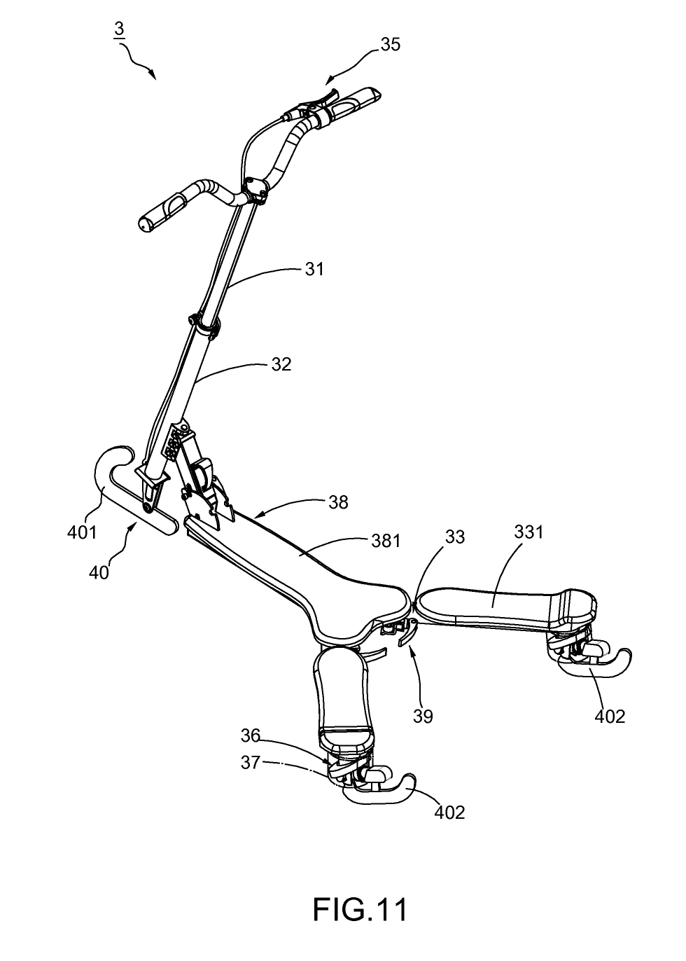

Referring to FIG. 11, the scooter 3 of a third preferred embodiment of the present invention comprises the elements, operations, and collapsible procedures similar to the second preferred embodiment. Particularly, a skate assembly 40 comprising of a front skate blade 401 and at least two rear skate blades 402 that are pivotally disposed instead of the previous wheel assembly 34 comprising the steering wheel 341 and the frame wheels 342 in the previous preferred embodiments, so that the user may have more fun enjoying the ice-skating and also possess the functionality of safety and convenience.

To sum up, the present invention takes advantage of a swingable assembly pivotally disposed between a main frame and a frame wheel and including a support seat vertically coupled to the main frame, In view of the swingable assembly forming a bevel surface inclined with respect to the support seat for a brace to fitly prop against and rotatably disposed thereon and support a connecting shaft to swing relative thereto, such configuration aids in effectively blocking the entry of barriers for keeping a smooth forwarding and decreasing the occurrence of harming users' hands. The swingable assembly also facilitates to a stable treading and a smooth forwarding via a manually wriggling method. The arrangement of the connecting shaft with respect to the bevel surface also promotes a buffer while riding on a defected ground, thus preferably increases operating safety and convenience.

While we have shown and described the embodiment in accordance with the present invention, it should be clear to those skilled in the art that further embodiments may be made without departing from the scope of the present invention.

What is claimed is:

1. A manual-swinging scooter comprising:
a steering stem having a handle disposed on a top end thereof;
a fixture extending downwardly from said steering stem, opposite to said handle;
a pair of main frames extending outwardly from said fixture, and two treadles being separately disposed on said main frames; and
a wheel assembly including a steering wheel pivotally connected to a distal end of said fixture and at least two frame wheels pivotally engaged to said main frames, respectively;
wherein, a swingable assembly being pivotally disposed between each of said main frames and each of said frame wheels; said swingable assembly further including a support seat vertically coupled to said main frame, a base fixed on said support seat, a rotary shaft pivoting to said support seat, a connecting shaft provided with two ends thereof pivotally and respectively engaged with said rotary shaft and said frame wheel, and a brace disposed on said connecting shaft; wherein, said base having a bevel surface inclined with respect to said support seat, and said brace propping against said bevel surface and equipping to slide thereon for allowably swinging said connecting shaft relative to said bevel surface.

2. The scooter as claimed in claim 1, wherein said bevel surface is inclined with respect to said support seat by an angle range of 40-80 degrees.

3. The scooter as claimed in claim 1, wherein said swingable assembly is surrounded by a sheath member.

4. The scooter as claimed in claim 1, wherein said bevel surface provides two opposite projecting portions disposed thereon to limit a swinging angle of said connecting shaft range of 100-140 degrees.

5. The scooter as claimed in claim 1, wherein a supporting frame has one end thereof connected to said fixture and thence with the other end thereof pivotally engaged with said main frames; said supporting frame further has a footboard disposed thereon.

6. The scooter as claimed in claim 5, wherein an adjustable device is disposed at a connection of said supporting frame and each of said main frames and includes two pivoted units respectively disposed on said supporting seat and said main frame and two fastening units securely disposed on said pivoted units.

7. The scooter as claimed in claim 1, wherein a skate assembly is pivotally disposed instead of said wheel assembly.

8. The scooter as claimed in claim 1, wherein a brake device is operatively secured to said handle, which includes at least one brake lever fastened to said handle, a brake pad mounted on said wheel assembly, and a brake cable connecting said brake lever with said brake pad.
